(19) United States
(12) Patent Application Publication
(10) Pub. No.: US 2007/0034293 A1
(43) Pub. Date: Feb. 15, 2007

(54) Treatment method for pattern wood and wood panel having treated pattern wood

(76) Inventor: Young Won Park, Seoul (KR)

Correspondence Address: BRUCE L. ADAMS, ESQ., Suite 1231, 17 BATTERY PLACE, NEW YORK, NY, 10004, US

(21) Appl. No.: 11/343,688

(22) Filed: Jan. 31, 2006

(30) Foreign Application Priority Data
Feb. 4, 2005 (KR) 10-2005-0010403

(51) Int. Cl. B27M 1/00; B27M 3/00

(52) U.S. Cl. 144/329

(57) ABSTRACT

A method of treating a pattern wood for a wood panel. A liquid mixture of Chinese herbs and medicines is prepared using Chun goong, Dan hyang, Jung hyang, Peppermint, Pyoh gwah, Gong sah in, Cinnamon, Dang gyih, Sam behk cho, Uh sung cho, and Behk hwa sa suhl cho. A pattern wood is heated in a vacuum tank at a temperature in the range of 70 to 90 degrees centigrade. The liquid mixture of Chinese herbs and medicines is poured on the pattern wood in the vacuum tank and the liquid mixture and pattern wood are maintained in the vacuum tank for a period of 1 to 4 hours. The pattern wood is then removed from the vacuum tank, dehydrated, dried.

### BACKGROUND OF THE INVENTION

1. Field of the Invention

The present invention relates to a method of treating a pattern wood using Chinese herbs and medicines, and to a wood panel having the treated pattern wood.

2. Background Information

The wood panel shown in FIGS. 1-2 has two layers of plywood 10 with a layer of a pattern wood 20 attached to the top of the plywood and with a glue or adhesive layer 30 disposed therebetween. In order to protect the wood panel, it is coated with a UV coating, and to block the odor from the glue, clay powder, ceramic powder, charcoal powder, and pulse rock powder are incorporated in the glue.

In the past, there have been provided wood panels with fragrances. However, the wood panels were applied with thin layers of a coating which emitted natural scents and also with a liquid created with beans. Although this did have a pleasant smell and was glossy, it wasn't beneficial to anyone's health.

### SUMMARY OF THE INVENTION

The present invention is directed to a method of treating a pattern wood using Chinese herbs and medicines, and to a wood panel comprising a plywood structure and the treated pattern wood attached to the top of the plywood structure. The treated pattern wood and wood panel is health conscious and environmentally safe as well.

The present invention will be used for floors and walls in houses and buildings. It will be beneficial for the health, and the Chinese herbs are incorporated in the two or more layers of plywood forming the plywood structure. How the herbs will be incorporated will be described in detail in the following paragraphs.

The most important part of the manufacturing method of the Chinese herb pattern wood is the fabrication of the top layer. It is composed of many different types of Chinese herbs and medicines including, Chun goong, Dan hyang, Jung hyang, Peppermint, Pyoh gwah, Gong sah in, Cinnamon, Dang gyih, Sam behk cho, Uh sung cho, and Behk hwa sa suhl cho. There are four steps in making the wood panel. First, each of the above herbs and medicines should consist no more than 10% of the overall mixture. The overall mixture is mixed with water and boiled to make a liquid herb. Such mixture should be combined with water resulting in a ratio in the range of 20% to 40% of this mixture and in the range of 60% to 80% of water resulting in a new mixture. Second, a pattern wood with a thickness in the range of 0.3 mm to 3 mm is steamed in a vacuum tank at a temperature in the range of 70 to 90 degrees centigrade. Then the herb and water mixture is poured onto the pattern wood and left to mature for 1 to 4 hours in the vacuum tank. Lastly, the pattern wood is taken out of the tank to be dehydrated and dried thoroughly.

In order to create the Chinese herb liquid, the Chinese herbs are wrapped in a net-like vessel, and are completely immersed under water inside a tank. The net-like vessel containing the Chinese herbs is then boiled in the water inside the tank for 2 to 5 hours at a temperature in the range of 110 to 130 degrees centigrade.

### BRIEF DESCRIPTION OF THE DRAWINGS

FIG. 1 is a perspective view of a wood panel having the pattern wood according to the present invention.

FIG. 2 is a cross-sectional side view of the wood panel shown in FIG. 1.

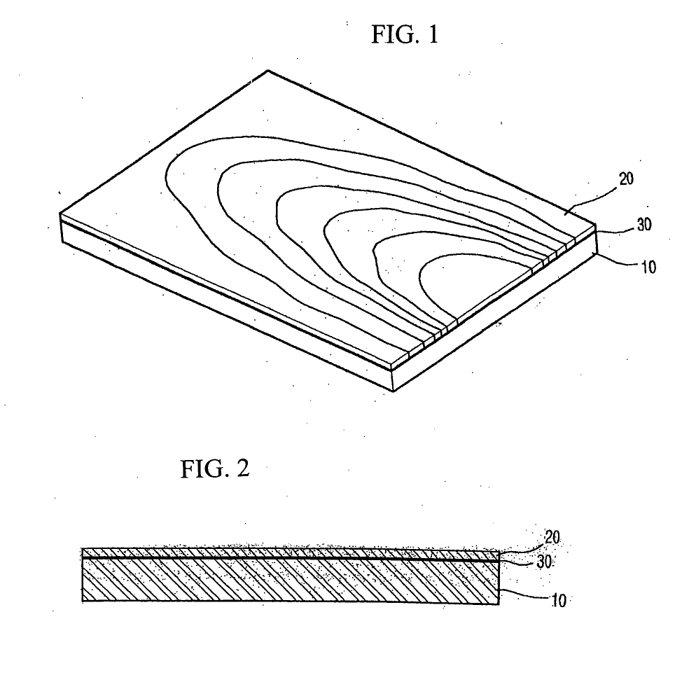

### DETAILED DESCRIPTION OF THE PREFERRED EMBODIMENT

The invention will now be described in detail below.

The effects of the Chinese herbs used in the manufacture of the Chinese herb pattern wood according to the present invention are described below.

Chun goong helps to create blood, helps the flow of blood, and also cleans it, and it is particularly helpful to women in aiding with their health. Due to its efficiency in alleviating pain, it is used in cases of headaches, and dizziness. Since, it helps blood flow quicker, it quickly gets rid of bad blood which might be stored in the body. Its strong ability to kill germs allows the body to quickly heal cuts and scratches. It also allows the maternal womb to decrease more quickly than usual after the baby is born.

Dan hyang restores the stomach and in turn, gives the person a better appetite. It also gets rid of tumors, heartburns, vomiting, stomachaches and diarrhea.

Jung hyang warms the stomach, allows better digestion of foods, helps to get rid of soreness, and helps to prevent the clotting of blood.

Peppermint helps skin become more tenacious, helps to stop itchiness and soreness, gives energy to listless bodies, and the aroma creates a pleasant atmosphere.

Pyo gwah helps people to urinate, abates bloating, helps subside the heat in the body, gets rid of the gallstones in the small intestine, heart, and lungs, and by aiding in the digestion of foods, it revives the appetite.

Gong sah in is good for the spleen, stomach, lungs, large intestine, small intestine, nerves and bladder, it restores energy, alleviates pain, and helps in the digestion of food.

Cinnamon helps the body to create stomach acid, helps to get rid of stomach aches, helps to excite nerves so blood flows quicker, warms the body and it helps to get rid of fermented foods. It helps people with cold bodies, people whose bodies swell due to weak hearts, people with weak bodies, people with back and leg pains, people whose stomachs become cold, and people who suffer from diarrhea and vomiting.

Cinnamon also lowers blood pressure, helps to prevent the clotting of blood and helps people who sweat too much. It is used commonly for colds and pain.

Dang gui helps in the creation of blood and in the flow of blood.

Sam behk cho treats jaundice, helps in the excretion of wastes, helps to get rid of flem, helps to get rid of hard chunks of materials in the stomach, helps in the treatment of tumors, helps to get rid of eczema, helps to lower body heat, helps to get rid of poison in the body, and helps to get rid of the water which accumulates due to liver cancer. It is also used in treating itchy skin.

Uh sung cho helps in the treatment of all tumors created because of high body heat, helps in the treatment of tumors in the lung, helps in the treatment of severe coughing and is helpful for people who cough out blood. In the most recent times it has been useful in treating pneumonia, inflammation of the intestines, and diarrhea.

Behk hwa sa suhl cho helps to get rid of poison, inflammation, helps in excreting urine, helps to digest food, and is helpful for people with liver, stomach, prostate, bladder, uterus and breast cancer.

Each Chinese herb ingredient must be mixed in similar proportion of quantity which is about 10% out of 100% to achieve the certain effect as described above. The proportion of the mixture of the Chinese herb is 20% to 40% out of 100%, and the rest of it is water. The Chinese herb wrapped with the net-type vessel must be immersed in the boiling water completely. The inside temperature of the water tank must be 110 to 130 degrees centigrade, and the boiling must be continued for 2 to 5 hours. The healthy component in the Chinese herbs will be accentuated in the water during these procedures. The Chinese herb liquid is made through these procedures.

The reason to wrap the Chinese herbs with a net-type vessel is to decrease the releasing of harmful ingredients like stem, leaf or root during the boiling in the water. The reason for boiling the water at temperatures in the range of 110 to 130 degrees centigrade is that temperatures lower than 110 degrees centigrade is not enough to extract the good components from the herbs, and temperatures higher than 130 degrees centigrade is a waste of energy.

Also, the reason for boiling the water for 2 to 5 hours is that less than the 2 hours is not enough to extract the good components out of the herbs, and that over 5 hours is a waste of energy. 10% of each of the Chinese herbs are mixed out of the 100% total mixture, and the total mixture must be 20% to 40% herbs and 60% to 80% water. The reason for this ratio is that an herb ratio less than this amount will cause the Chinese herb liquid to become too watery and a water ratio less than this amount will cause the herbs to not completely be dissolved in the water. Purified water should be used in this process.

After finishing the boiling, the net-type vessel must be taken out of the water tank. The Chinese herbs in the net-type vessel must be squeezed to extract the liquid soaked in the herb, and the extracted liquid will be added in the boiling water tank. This Chinese herb liquid must be preserved in a place with a temperature lower than 10 degrees centigrade. If the temperature is higher than 10 degrees centigrade, the Chinese herb liquid might be spoiled.

Before pouring the Chinese herb liquid on the pattern wood having a thickness in the range of 0.3 mm to 3 mm, the wood must be prepared through a certain process. The pattern wood must be heated in a vacuum tank at a temperature in the range of 70 to 90 degrees centigrade to remove the moisture and air contained in it. This process will be highly effective for permeating the Chinese herb liquid into the pattern wood.

The reason for heating up the vacuum tank at temperatures in the range of 70 to 90 degrees centigrade is that lower temperatures will cause the moisture in the wood to not be vaporized thoroughly, and temperature higher than this will cause the wood to crack or twist. The general thickness of the pattern wood is in the range of 0.3 mm to 3 mm.

The next procedure is to pour the Chinese herb liquid on the prepared pattern wood in the vacuum tank, and to let it mature for 1 to 4 hours. The most effective length of time for maturing the wood is 2 hours.

After finishing the maturing, the pattern wood is taken out of the vacuum tank and dehydrated in a dehydration machine. Then the pattern wood is kept in temperatures lower than 10 degrees centigrade.

The foregoing provides a description of the method of making the Chinese herb pattern wood. The Chinese herb pattern wood is then attached on the top of a plywood having 2 or more layers to form the wood panel. The wood panel can be generally installed on the floors or walls inside of buildings.

Thus the present invention provides a wood panel comprised of a plywood structure having two or more layers of plywood and a pattern wood attached on top of the plywood structure with Chinese herbs and medicines spread throughout. The wood panel is health conscious and environmentally safe as well. This invention is used for floors and walls in many types of buildings and homes. It is composed of many different types of Chinese herbs and medicines including Chun goong, Dan hyang, Jung hyang, Peppermint, Pyoh gwah, Gong sah in, Cinnamon, Dang gyih, Sam behk cho, Uh sung cho, and Behk hwa sa suhl cho. As described above, there are four steps in making the wood panel. First, the above herbs and medicines consist of no more than 10% of the overall mixture. The overall mixture is mixed with water and boiled to make a liquid herb. Such mixture is combined with water resulting in a ratio of 20% to 40% of this mixture and 60% to 80% of water resulting in a new mixture. Second, the pattern wood with a thickness in the range of 0.3 mm to 3 mm is steamed in a vacuum tank at a temperature in the range of 70 to 90 degrees centigrade. Then the herb and water mixture is poured onto the pattern wood and left to mature for 1 to 4 hours in the vacuum tank. Lastly, the pattern wood is taken out of the tank, dehydrated, and dried thoroughly.

The present invention would help the consumer's health and provide comfort to the consumer during use as a floor or wall structure because of the herbal ingredients on the pattern wood.

1-2. (canceled)

3. A method of treating a pattern wood for a wood panel, comprising the steps of:
preparing a liquid mixture of Chinese herbs and medicines using Chun goong, Dan hyang, Jung hyang, Peppermint, Pyoh gwah, Gong sah in, Cinnamon, Dang gyih, Sam behk cho, Uh sung cho, and Behk hwa sa suhl cho;
heating a pattern wood in a vacuum tank at a temperature in the range of 70 to 90 degrees centigrade;
pouring the liquid mixture of Chinese herbs and medicines on the pattern wood in the vacuum tank and maintaining the liquid mixture and pattern wood in the vacuum tank for a period of 1 to 4 hours;
removing the pattern wood from the vacuum tank;
dehydrating the pattern wood; and
drying the pattern wood.

4. A method according to claim 3; wherein the preparing step comprises the steps of wrapping the Chinese herbs and medicines in a net-type vessel; and boiling in a water tank containing water the net-type vessel containing the Chinese herbs and medicines at a temperature in the range of 110 to 130 degrees centigrade for 2-5 hours.

5. A method according to claim 4; wherein the pattern wood has a thickness in the range of 0.3 mm to 3 mm.

6. A method according to claim 3; wherein the pattern wood has a thickness in the range of 0.3 mm to 3 mm.

7. A method according to claim 3; wherein each of the Chinese herbs and medicines consist of no more than 10% of the overall mixture.

8. A method according to claim 3; wherein the mixture contains 20% to 40% of the Chinese herbs and medicines and 60% to 80% of water.

9. A method according to claim 3; wherein in the pouring step, the maintaining step comprises the step of maintaining the liquid mixture and the pattern wood in the vacuum tank for 2 hours.

10. A method of manufacturing a wood panel, comprising the steps of: preparing a treated pattern wood as set forth in claim 3; and attaching the treated pattern wood to a surface of a plywood structure to form the wood panel.

11. A method according to claim 10; wherein the pattern wood has a thickness in the range of 0.3 mm to 3 mm.

12. A method of manufacturing a wood panel, comprising the steps of: preparing a treated pattern wood as set forth in claim 4; and attaching the treated pattern wood to a surface of a plywood structure to form the wood panel.

13. A method according to claim 12; wherein the pattern wood has a thickness in the range of 0.3 mm to 3 mm.

14. A wood panel comprising:
a plywood structure; and
a pattern wood treated according to the method of claim 3 attached to a surface of the plywood structure.

15. A wood panel according to claim 14; wherein the pattern wood has a thickness in the range of 0.3 mm to 3 mm.
